(19) United States
(12) Patent Application Publication
(10) Pub. No.: US 2024/0352954 A1
(43) Pub. Date: Oct. 24, 2024

(54) HYDRAULIC SYSTEM, MINING VEHICLE AND METHOD

(71) Applicant: SANDVIK MINING AND CONSTRUCTION OY, Tampere (FI)

(72) Inventors: Pertti PARKKINEN, Tampere (FI); Samuli VERHO, Tampere (FI); Teemu HONGELL, Tampere (FI)

(21) Appl. No.: 18/685,331

(22) PCT Filed: Aug. 2, 2022
(86) PCT No.: PCT/EP2022/071695

§ 371 Date: Feb. 21, 2024

(30) Foreign Application Priority Data
Aug. 23, 2021 (EP) 21192506.0

(51) Int. Cl. F15B 21/00; F15B 15/18; F15B 19/00

(52) U.S. Cl. CPC F15B 21/005; F15B 15/18; F15B 19/00

(57) ABSTRACT

A hydraulic system, mining vehicle, and method for flushing a closed loop hydraulic circuit is provided. The hydraulic system includes at least one closed hydraulic circuit having a hydraulic pump, a motor and one or more hydraulic actuators. The hydraulic system further includes a flushing system arranged for discharging and feeding a limited amount of hydraulic fluid for flushing the closed loop hydraulic circuit. There is a discharge valve, which is actively controlled by a control unit so that fluid flow through the valve is selectively controlled.

### BACKGROUND OF THE INVENTION

The invention relates to a hydraulic system of a mining vehicle. The hydraulic system is provided with a closed loop hydraulic circuit. The closed loop hydraulic circuit is flushed by means of a flushing system.

The invention further relates to a mining vehicle and to a method of flushing a closed loop hydraulic circuit of a hydraulic system by means of a flushing system.

The field of the invention is defined more specifically in the preambles of the independent claims.

In mines and at other work sites different type of mining vehicles are used. The mining vehicles are provided with several hydraulic actuators which are connected to a hydraulic system. Further, the hydraulic system may comprise one or more closed loop hydraulic systems wherein pressurized hydraulic fluid is circulated from an outlet port of a hydraulic pump to an inlet port of the hydraulic actuator, and further from an outlet port of the hydraulic actuator to an inlet port of the first hydraulic pump. However, there may be a need to flush the closed loop hydraulic system by feeding fresh hydraulic fluid therein. In some known solutions flushing of the closed hydraulic system is executed by means of o flushing fluid flow produced by means of a flushing pump connected to be driven simultaneously and parallel to the main hydraulic pump. Then the produced flushing flow and pressure is controlled by a separate control valve. The known solutions for the flushing have shown to have some disadvantages which relate especially to poor energy efficiency and to unsatisfactory controllability of the flushing.

### BRIEF DESCRIPTION OF THE INVENTION

An object of the invention is to provide a novel and improved hydraulic system, a mining vehicle equipped with such closed hydraulic system and a method for flushing a closed loop hydraulic circuit.

The hydraulic system according to the invention is characterized by the characterizing features of the first independent apparatus claim.

The mining vehicle according to the invention is characterized by the characterizing features of the second independent apparatus claim.

The method according to the invention is characterized by the characterizing features of the independent method claim.

An idea of the disclosed solution is that a closed loop hydraulic circuit of a hydraulic system is provided with a flushing system comprising at least one feed arrangement for feeding limited amount of additional hydraulic fluid to the closed loop hydraulic circuit from a separate hydraulic fluid source, and a discharge arrangement for discharging limited amount of used hydraulic fluid from the closed loop hydraulic circuit to the separate hydraulic fluid source. Thereby the flushing system provides the closed loop hydraulic circuit with a limited flushing flow by controlling the feed and discharge. In the disclosed solution the mentioned discharge arrangement comprises at least one discharge valve which is actively controlled under control of at least one control unit and wherein fluid flow through the discharge valve is selectively controllable.

In other words, the closed loop hydraulic circuit is provided with an actively controlled by-pass flow system allowing limited flow of pressure fluid to be fed to the closed loop hydraulic circuit and out of it to ensure proper quality of the hydraulic fluid in the system.

An advantage of the disclosed solution is that the flushing can be controlled effectively and accurately when the control unit controls the by-pass flow system actively. The control unit may also monitor several parameters and take them account in the control of the flushing. More versatile flushing control principles and situations can be implemented when the active control is executed by means of the control unit. Further, the improved control makes the system also more effective and saves energy.

In the closed loop hydraulic circuit pressurized hydraulic fluid flows directly from the hydraulic pump to the hydraulic actuator, which is typically a hydraulic motor, and returns directly to the hydraulic pump without entering a tank or other hydraulic fluid reservoir. The flow and direction of the hydraulic fluid controls the hydraulic motor. The hydraulic motor can operate in either directions. In the closed loop system hydraulic pressure and flow is generated only when needed and only as much as required.

According to an embodiment, the feed arrangement may comprise one or more feed valves for controlling feeding of fresh hydraulic fluid to the closed loop hydraulic circuit.

According to an embodiment, the feed arrangement and the discharge arrangement are both in direct fluid connection with a tank serving as the separate hydraulic fluid source.

According to an embodiment, the hydraulic system comprises at least one filtering or cooling device for treating the discharged hydraulic fluid before feeding it through the feed arrangement to the closed loop hydraulic circuit. The filtering or cooling device may be arranged in connection with the fluid source or storage.

According to an embodiment, the mentioned feed arrangement comprises a second hydraulic pump driven by means of at least one dedicated second motor. In other words, the disclosed flushing arrangement comprises a separate hydraulic pump for producing the required flushing flow. The pump is actuated by means of a dedicated motor, whereby the operation of the pump is controllable independently relative to the pumping means of the closed loop hydraulic circuit.

According to an embodiment, the hydraulic system comprises an open hydraulic circuit serving as a common rail hydraulic circuit and configured to provide hydraulic fluid for the flushing system and for at least one hydraulic actuator coupled to the open hydraulic circuit. The open hydraulic circuit is provided with a second hydraulic pump driven by means of at least one dedicated second motor under control of the control unit. In this embodiment, the second hydraulic pump can be utilized not only for the flushing purpose but also to drive selected hydraulic auxiliary devices of the mining vehicle. Then no separate hydraulic pump is needed only for the flushing.

According to an embodiment, at least the second motor is a speed controlled electric motor controlled by means of at least one electrical motor control device and at least the second hydraulic pump is a fixed displacement pump. Then the control unit is configured to control the mentioned electrical motor control device for adjusting magnitude of pressure and flow of the hydraulic fluid affecting in the feed arrangement of the flushing system.

According to an embodiment, the second hydraulic pump for producing the flushing flow may alternatively be any kind of hydraulic pump. Thus, the second hydraulic pump may be a variable displacement pump, for example.

According to an embodiment, the closed loop hydraulic circuit is provided with one or more sensing devices for sensing properties of the hydraulic fluid. The control unit is provided with the sensing data and generates control signals for controlling at least the discharge valve in response to the sensing data.

According to an embodiment, the sensing data mentioned in the previous embodiment is also used for controlling operation of the second motor and magnitude of the produced flushing flow.

According to an embodiment, the mentioned sensing device is a temperature sensor for sensing temperature of the hydraulic fluid. The control unit may control the flushing for cooling the temperature of the circuit.

According to an embodiment, the mentioned sensing device is a fluid condition monitoring sensor for sensing fluid properties of the hydraulic fluid.

According to an embodiment, the fluid condition monitoring sensor is a sensor or analyzing device for detecting cleanliness of the hydraulic fluid.

According to an embodiment, the closed loop hydraulic circuit is further provided with one or more pressure or flow sensors. The produced sensing data is transmitted to the control unit. Furthermore, temperature of the pressure fluid can be sensed in connection with at least one hydraulic actuator. The control unit may be configured to provide control signals in response to the received sensing data.

According to an embodiment, the control unit detects operational state of the closed loop hydraulic circuit and generates control signals in response to the detected operational state for controlling at least the discharge calve of the flushing system.

According to an embodiment, the control unit is configured to detect use ratio of the closed loop hydraulic circuit and is configured to increase the flushing when the detected use ratio exceeds a predetermined limit value.

According to an embodiment, the control unit is configured to detect operating time or period of the closed loop hydraulic circuit and is configured to increase the flushing when the detected operating time exceeds a predetermined limit value.

According to an embodiment, the control unit is configured to monitor operation of the closed loop hydraulic circuit and is configured to increase the flushing when cumulative magnitudes of loadings, or estimated magnitudes of loadings of the forthcoming operations exceed predetermined limit values set for the loadings.

According to an embodiment, the control unit is configured to operate the flushing system for continuing cooling of the pressure fluid in the closed loop hydraulic circuit even when operation of the closed loop hydraulic circuit is switched off. This way a kind of aftercooling can be implemented for cooling the hydraulic fluid independently and for desired period. This way the hydraulic system may be prepared for forthcoming operations.

According to an embodiment, the control unit is configured to detect operational conditions where the closed loop hydraulic circuit operates. The control unit may increase the flushing when operating in harsh conditions and high temperatures, for example.

According to an embodiment, the control unit may be provided with a user interface by means of which an operator of the mine vehicle can communicate with the control unit, may input control parameters, and can make selections. The control unit may provide the operator with usable information by means of the user interface.

According to an embodiment, the disclosed solution relates to a mining vehicle. The mining vehicle comprises a movable carrier and one or more mining work devices mounted on the carrier. The mining vehicle further comprises at least one hydraulic system which is in accordance with the embodiments and features disclosed in this document.

According to an embodiment, the mining vehicle is a rock drilling rig, a rock bolting device, a shotcreting device, a mine loading vehicle, or a mine truck. The disclosed closed loop hydraulic circuit may be arranged to operate a tramming or driving actuator, or a mining actuator, for example.

According to an embodiment, the disclosed solution relates to a method of flushing a closed loop hydraulic circuit of a hydraulic system by means of a flushing system. The method comprises feeding additional hydraulic fluid to the closed loop hydraulic circuit and discharging hydraulic fluid from the closed loop hydraulic circuit. The method further comprises controlling at least magnitude of the discharge of the hydraulic fluid by means of a control unit.

The above disclosed embodiments may be combined in order to form suitable solutions having those of the above features that are needed.

### BRIEF DESCRIPTION OF THE FIGURES

Some embodiments are described in more detail in the accompanying drawings, in which

FIG. 1 is a schematic view of a hydraulic diagram of the disclosed hydraulic system comprising a closed loop hydraulic circuit and a flushing system for flushing it,

FIG. 2 is a schematic diagram showing some control principles of the disclosed solution, and

FIG. 3 is a schematic view of an alternative hydraulic diagram of the disclosed hydraulic system.

For the sake of clarity, the figures show some embodiments of the disclosed solution in a simplified manner. In the figures, like reference numerals identify like elements.

### DETAILED DESCRIPTION OF SOME EMBODIMENTS

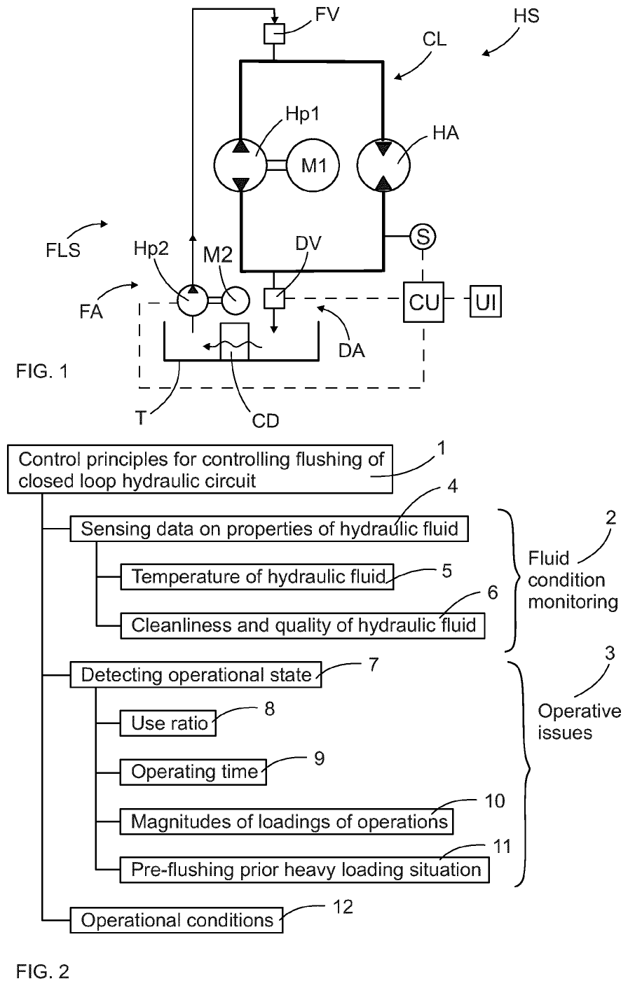

FIG. 1 shows a hydraulic diagram of a hydraulic system HS of a mining vehicle, such as a rock drilling rig. The hydraulic system HS is provided with a closed loop hydraulic circuit CL comprising a first hydraulic pump Hp1 driven by means of a first motor M1. A hydraulic actuator HA is connected to the closed loop hydraulic circuit CL. As it is shown in FIG. 1, pressurized hydraulic fluid is directed to circulate in the closed loop hydraulic circuit CL from an outlet port of the first hydraulic pump Hp1 to an inlet port of the hydraulic actuator HA and further from an outlet port of the hydraulic actuator HA to an inlet port of the first hydraulic pump Hp1. In FIG. 1 the first hydraulic pump Hp1 and the hydraulic actuator Hp can be rotated to both rotational directions wherefore the inlet and outlet ports are not marked for clarity reasons.

The hydraulic system HS comprises a flushing system FLS provided with a feed arrangement FA for feeding limited amount of additional hydraulic fluid to the closed loop hydraulic circuit CL from a separate hydraulic fluid source T, and is also provided with a discharge arrangement DA for discharging limited amount of used hydraulic fluid from the closed loop hydraulic circuit CL to the separate hydraulic fluid source T. The separate hydraulic fluid source T may be a tank or reservoir, for example.

The mentioned discharge arrangement DA further comprises a discharge valve DV which is actively controlled under control of a control unit CU. Fluid flow through the discharge valve DV can be selectively controlled under control of the control unit CU. The control unit CU may comprise a processor configured to generate control signals in response to sensing data received from one or more sensing devices S. The control unit CU may be provided with a user interface UI for communicating with an operator. Control parameters and computer program products may be input to the control unit CU.

The mentioned feed arrangement FA comprises a second hydraulic pump Hp2 driven by means of a dedicated second motor M2. The feed arrangement further comprises a feed valve for controlling feeding of fresh hydraulic fluid to the closed loop hydraulic circuit CL.

The feed arrangement FA and the discharge arrangement DA are both in direct fluid connection with a tank serving as the separate hydraulic fluid source T.

There may be one or more filtering or cooling devices CD for treating the discharged hydraulic fluid before feeding it through the feed arrangement FA to the closed loop hydraulic circuit CL. The filtering or cooling device CD may be arranged in connection with the fluid source T.

FIG. 2 discloses some control principles 1 for controlling flushing of closed loop hydraulic circuit. The control 1 may be based on fluid control monitoring 2 or operative issues 3, or both. The fluid condition monitoring 2 may comprise sensing data on properties of the hydraulic fluid 4. Then there is one or more fluid condition monitoring sensors for sensing fluid properties of the hydraulic fluid. A temperature sensor may be provided for sensing temperature of the hydraulic fluid 5. The control unit may control the flushing for cooling the temperature of the circuit. Alternatively, or in addition to, there may be one or more fluid condition monitoring sensors or analyzing devices for detecting cleanliness of the hydraulic fluid 6.

The mentioned operative issues 3 may relate to detecting operational state 7 of the closed loop hydraulic circuit. The control may take into account use ration 8, operating time 9, magnitudes of loadings of operations 10, and may also arrange pre-flushing prior forthcoming loading situations 11.

Furthermore, the control unit may detect operational conditions 12 where the closed loop hydraulic circuit operates. Then the control unit may increase the flushing when operating in harsh conditions and high temperatures, for example.

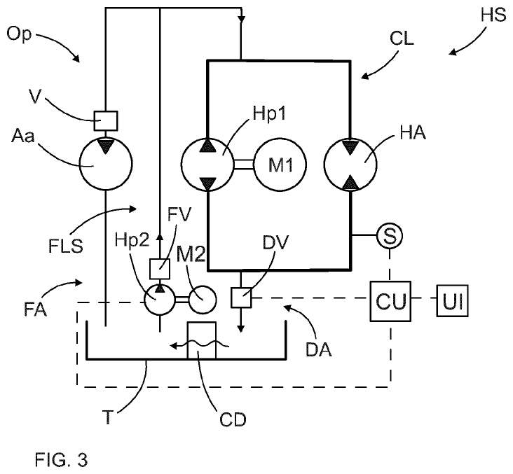

FIG. 3 discloses a hydraulic system HS that differs from the one shown in FIG. 1 only in that the second pump Hp2 is configured to produce hydraulic power also for an open loop hydraulic circuit Op provided with one or more hydraulic auxiliary actuators Aa. There may be a valve V for controlling feeding of hydraulic fluid in the open loop hydraulic circuit Op to auxiliary actuators Aa. The open loop hydraulic circuit comprising the auxiliary actuator Aa may also be called as common rail circuit.

The drawings and the related description are only intended to illustrate the idea of the invention. In its details, the invention may vary within the scope of the claims.

1. A mining vehicle, comprising:
a movable carrier:
at least one mining work device mounted on the carrier; and
at least one hydraulic system, wherein the at least one hydraulic system is provided with at least one closed loop hydraulic circuit comprising:
at least one first hydraulic pump driven by at least one first motor;
at least one hydraulic actuator, wherein pressurized hydraulic fluid is directed to circulate in the at least one closed loop hydraulic circuit from an outlet port of the at least one first hydraulic pump to an inlet port of the at least one hydraulic actuator and further from an outlet port of the at least one hydraulic actuator to an inlet port of the at least one first hydraulic pump;
a flushing system including at least one feed arrangement arranged for feeding a limited amount of additional hydraulic fluid to the at least one closed loop hydraulic circuit from a separate hydraulic fluid source, and a discharge arrangement arranged for discharging a limited amount of used hydraulic fluid from the at least one closed loop hydraulic circuit to the separate hydraulic fluid source, wherein the discharge arrangement includes at least one discharge valve, which is actively controlled under control of at least one control unit and wherein fluid flow through the discharge valve is selectively controllable:
the at least one hydraulic system including an open hydraulic circuit arranged as a common rail hydraulic circuit and configured to provide hydraulic fluid for the flushing system and for at least one hydraulic actuator coupled to the open hydraulic circuit, wherein the open hydraulic circuit is provided with a second hydraulic pump driven by at least one dedicated second motor arranged under control of the at least one control unit.

2. The mining vehicle as claimed in claim 1, wherein the at least one closed loop hydraulic circuit is provided with at least one sensing device arranged for sensing properties of the hydraulic fluid, and wherein the at least one control unit is configured to receive sensing data from the sensing device and is configured to generate control signals in response to the received sensing data for controlling at least the discharge valve of the flushing system.

3. The mining vehicle as claimed in claim 2, wherein the sensing device is a temperature sensor arranged for sensing temperature of the hydraulic fluid.

4. The mining vehicle as claimed in claim 2, wherein the sensing device is a fluid condition monitoring sensor arranged for sensing fluid properties of the hydraulic fluid.

5. The mining vehicle as claimed in claim 1, wherein the at least one control unit is configured to detect an operational state of the at least one closed loop hydraulic circuit and is configured to generate control signals in response to the detected operational state for controlling at least the discharge valve of the flushing system.

6. (canceled)
